(19) United States
(12) Patent Application Publication
(10) Pub. No.: US 2024/0189924 A1
(43) Pub. Date: Jun. 13, 2024

(54) Cutting Body and Drilling Tool Having a Cutting Body

(71) Applicant: Robert Bosch GmbH, Stuttgart (DE)

(72) Inventors: Haifeng Ji, Lishui (CN); Zhenglin Yang, Hangzhou (CN); Fabian Geissmann, Biberstein (CH); Andrea Pedretti, Rivera (CH); Long Zhou, Hangzhou (CN); Massimo Anghileri, Solothurn (CH); Sonia Wang, Park Ridge, IL (US)

(21) Appl. No.: 18/549,788

(22) PCT Filed: Mar. 11, 2022
(86) PCT No.: PCT/EP2022/056306

§ 371 Date: Sep. 8, 2023

(30) Foreign Application Priority Data
Mar. 16, 2021 (DE) 10 2021 202 559.5

(51) Int. Cl. B23B 51/00; B23B 51/02

(52) U.S. Cl. CPC B23B 51/0003; B23B 51/02

(57) ABSTRACT

A cutting body for a drilling tool has a center axis, at least one cutting element with at least one cutting edge, and at least one side face. The at least one side face has at least one radially inwardly directed cutout, which is designed to produce a drilled hole having an increased roughness, the cutout having precisely three open sides.

### THE PRIOR ART

DE 10 2014 203 327 A1 describes a drilling tool having a transport area for transporting bore dust.

### DISCLOSURE OF THE INVENTION

The invention relates to a cutting body for a drilling tool having a center axis, having at least one cutting element, the cutting element having at least one cutting edge, and the cutting body comprising at least one side face. According to the invention the at least one side face has at least one radially inwardly directed cutout which is designed to produce a drilled hole having an increased roughness, the cutout having precisely three open sides. Advantageously, a cutting body with a high wear resistance can be realized.

The drilling tool is in particular designed as a rock drill provided for a drill hammer. Alternatively, it is also conceivable that the drilling tool be designed as a wood drill, tile drill, step drill, weld point drill, etc. The drilling tool can be designed to be integral or in one piece. In the context of this application, the term “integral” is understood to mean a component that is designed to be made of one piece and not made of multiple components connected to one another in a bonded, and/or frictional, and/or interlocking manner. Accordingly, an integral component consists of a single material. In the context of this application, the term “in one piece” is in particular understood to mean multiple components connected to one another in a bonded manner.

Along its long axis or rotational axis in particular, the drilling tool comprises an insertion end, a conveyor coil, and a drill head, with the drill head comprising the cutting body.

The drill head can be designed to be integral with the drilling tool, in particular with the conveyor coil of the drilling tool. The term “drill head” is in particular understood to mean an area of the drilling tool comprising at least one cutting body. The drill head can also comprise a plurality of cutting bodies. The cutting body comprises at least one cutting element, which can be designed as a main cutting element or a secondary cutting element. The cutting elements are in particular made of a carbide. Preferably, the cutting elements have a greater hardness than the conveyor coil. The drilling tool preferably comprises one cutting element for each spiral gear. The cutting elements can be associated with a single cutting body, or they can can be distributed among multiple cutting bodies.

Each cutting element comprises at least one cutting edge. The cutting edge in particular corresponds to the intersection lines of a cutting surface and a flank surface of the cutting element. Each cutting element preferably comprises a single cutting edge. Alternatively, the cutting element can also comprise a plurality of cutting edges, which in particular transition into one another. The cutting element has a cutting angle α, which in particular measures within a range between 0° and 20°, preferably within a range between 0° and 10°, more preferably within a range between 0° and 5°. Alternatively, it is also conceivable that the cutting angle α be negatively designed and in particular measure within a range between 0° and −20°, preferably within a range between 0° and −10°, more preferably within a range between 0° and −5°. The cutting element has a wedge angle β, which is preferably less than 90°. The cutting element has a clearance angle γ, which in particular measures within a range between 0° and 25°, preferably within a range between 5° and 20°, more preferably within a range between 5° and 10°.

Preferably, the drill head is connected to the conveyor coil in a bonded manner. The connection can be made, e.g., via a soldering process or a welding process. The cutting body is in particular made of a carbide. The cutting body can, e.g., be designed as a carbide plate or as a solid carbide head. A cutting body designed as a carbide plate is, e.g., inserted into a slot in the front of the base body for connection to a base body of the drilling tool. A cutting body designed as a solid carbide head is placed on a blunt surface of the base body for connection in a bonded manner to the base body of the drilling tool.

At its end facing away from the drill head, the drilling tool has an insertion end designed to be coupled to a machine tool, in particular a hand-held machine tool such as a drill hammer. Preferably, the drilling tool is designed in the area of the insertion end such that the drilling tool can be coupled to a tool holder of the hand-held machine tool. By way of example, the drilling tool in the area of the insertion end can have form-locking elements designed as special grooves that form an SDS plus interface or an SDS max interface. To machine a part, the drilling tool is placed in a rotating as well as linearly oscillating or striking state by means of the drill hammer. The drilling tool penetrates the part during machining in the feed direction of the drilling tool. The feeding direction of the drilling tool is coaxial to the longitudinal axis of the drilling tool and starts from the insertion end towards the drill head. In particular, the longitudinal axis of the drilling tool corresponds to a working or rotational axis of the drilling tool. The longitudinal axis of the drilling tool substantially corresponds to the longitudinal axis of the conveyor coil.

The at least one side face borders the cutting body in a radially outward direction. In particular, the side face has a distance from the center axis of the cutting body that is maximal and corresponds to the radius of the cutting body or substantially the radius of the drilled hole that can be produced with the cutting body. The side face extends substantially parallel to the center axis of the cutting body and/or the longitudinal axis of the drilling tool. Preferably, a cutting body designed as a carbide plate has preferably exactly two side faces, which are preferably arranged parallel to one another. A cutting body designed as a solid carbide head can have three, four, five or more side faces. In particular, the cutting body comprises one side face for each cutting element. The side face is designed as a wear surface.

The three open sides are arranged perpendicular or parallel to each other. The cutout comprises one middle and two outer open sides. The middle open side interrupts the side face, in particular the wear surface. The middle open side of the drilled hole is substantially closed in the drilled hole by the inner wall of the drilled hole. The two outer open sides are arranged parallel to each other and are also not designed to be closed in the drilled hole.

Furthermore, it is proposed that the side face has a minimum distance from the center axis in the area of the cutout. In particular, the cutting body has a minimum diameter in the area of the cutout.

Furthermore, it is proposed that the cutout is designed such that the diameter of the cutting body along the center axis in the direction of the cutout initially decreases and increases after the cutout. Advantageously, doing so can extend the service life of the cutting body.

In addition, it is proposed that the cutout is designed in an angular or concave manner. For example, the angular cutout can be designed in a square, rectangular, triangular, or polygonal manner. In particular, one of the open sides, preferably at least one of the outer open sides, has a square, rectangular, triangular or polygonal or concave shape.

Furthermore, it is proposed that the side face has two or more cutouts. The cutouts on the same side face can be designed to be substantially the same, or to be different. The cutouts can in this case vary in shape and/or size. Advantageously, doing so can further increase the roughness of the drilled hole.

Furthermore, it is proposed that the cutting body comprise a second side face having at least one cutout. Advantageously, doing so can further increase the roughness of the drilled hole. The second side face and the first side face can have the same number or different number of cutouts. Additionally, it is conceivable that the first side face and the second side face can have cutouts having the same shapes and/or sizes. Alternatively, it is also conceivable that the first side face and the second side face have cutouts having different sizes and/or shapes.

In addition, it is proposed that a distance between the cutout and a cutting surface of the cutting body measures within a range between 10% and 40% of a length of the side face, preferably within a range between 10% and 30% of the length of the side face, more preferably within a range between 10% and 20% of the length of the side face. Advantageously, doing so can ensure a long service life of the cutting body. The distance is, in particular, a distance along the center axis of the cutting body or along the longitudinal axis of the drilling tool. In particular, the cutting surface of the cutting body comprises at least one, preferably all, cutting edges of the cutting body. The machining surface extends cross-sectionally to the center axis of the cutting body and has a drill head tip. For example, the drill head tip can be designed as a centering tip or also as a transverse cut. The length of the side face is in particular measured along the center axis of the cutting body or along the longitudinal axis of the drilling tool. Preferably, the distance of the cutout from the machining surface is at least 0.5 mm. On a side facing away from the machining surface, the cutting body has a joining surface for connection to the base body of the drilling tool. The joining surface is preferably planar. The distance of the cutout from the joining surface is preferably at least 0.5 mm. In particular, the distance of the cutout from the machining surface substantially corresponds to the distance of the cutout from the joining surface.

Furthermore, it is proposed that a length (h) of the cutout measures within a range

0.15 mm≤h≤H_{HM}−C,
where
H_{HM} is the length of the side face, and
C is the distance of the cutout from the machining surface.

The length h is in particular a maximum length of the cutout along the center axis of the cutting body or the longitudinal axis of the drilling tool.

Furthermore, the invention relates to a drilling tool having a cutting body, wherein the drilling tool has a longitudinal axis extending coaxially or parallel to a center axis of the cutting body, wherein the cutting body has at least one cutting element, wherein the cutting element has at least one cutting edge, wherein the cutting body has at least one side face. According to the invention, the at least one side face has one radially inwardly directed cutout which is designed to produce a drilled hole having an increased roughness, the cutout having precisely three open sides.

It is also proposed that the cutting body be designed as one-piece with the drilling tool or is connected to a base body of the drilling tool in a bonded manner.

Furthermore, it is proposed that a diameter of the base body in the area of the cutout substantially corresponds to the minimum diameter of the cutting body. The base body in particular comprises a conveyor coil, which is provided for the removal of drill cuttings or dust. The conveyor coil comprises at least one spiral gear that extends in a straight line or spirally around the longitudinal axis of the drilling tool. The diameter of the base body in particular corresponds to an average diameter of the base body in the area of the conveyor coil. In this context, a minimum diameter of the cutting body is understood to mean a minimum diameter of the cutting body in the area of the cutout.

It is further proposed that the base body of the drilling tool has a diameter reduction in the area of the cutout. The term “diameter reduction” is in this context understood to mean that the base body of the drilling tool has a smaller diameter in the area of the cutout than the average diameter in the area of the conveyor coil. Advantageously, doing so can further increase the roughness.

It is also proposed that a diameter D of the cutting body in the area of the cutout measures within a range of

0.8*d₀₂≤D≤D_{HM}−0.2*H_{HM}*n
where
d₀₂ is a diameter of the drilling tool in the area of the conveyor coil,
D_{HM} is in particular a maximum diameter of the cutting body;
H_{HM} is the length of the side face and
n is the number of the side faces with at least one cutout.

Advantageously, a high roughness of the drilled hole can be achieved while simultaneously providing a high service life for the cutting body. In particular, the upper limit is D_{HM}−0.1*H_{HM}*n, preferably the upper limit is D_{HM}. Alternatively or additionally, it is also conceivable that the lower limit be 0.9*d₀₂, preferably d₀₂.

### DRAWINGS

Further advantages will become apparent from the following description of the drawings. The drawings, the description, and the claims contain numerous features in combination. The skilled person will appropriately also consider the features individually and combine them to form further meaningful combinations. Various embodiments are identified by an additional letter.

### Shown are:

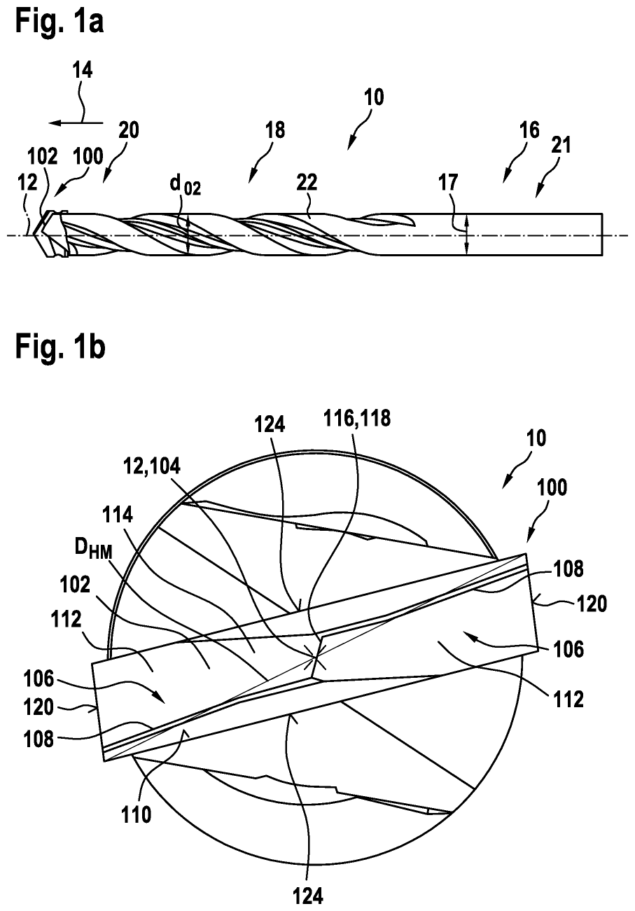

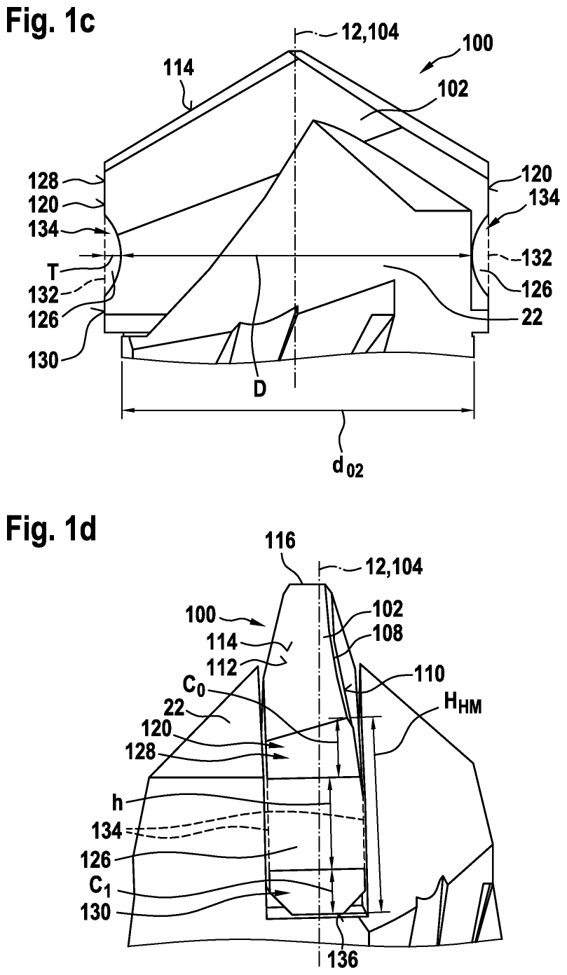

FIG. 1a a side view of a drilling tool with a cutting body according to the invention;

FIG. 1b a top view of the drilling tool according to FIG. 1a;

FIG. 1c a side view of the cutting body according to FIG. 1a;

FIG. 1d a further side view of the cutting body according to FIG. 1a;

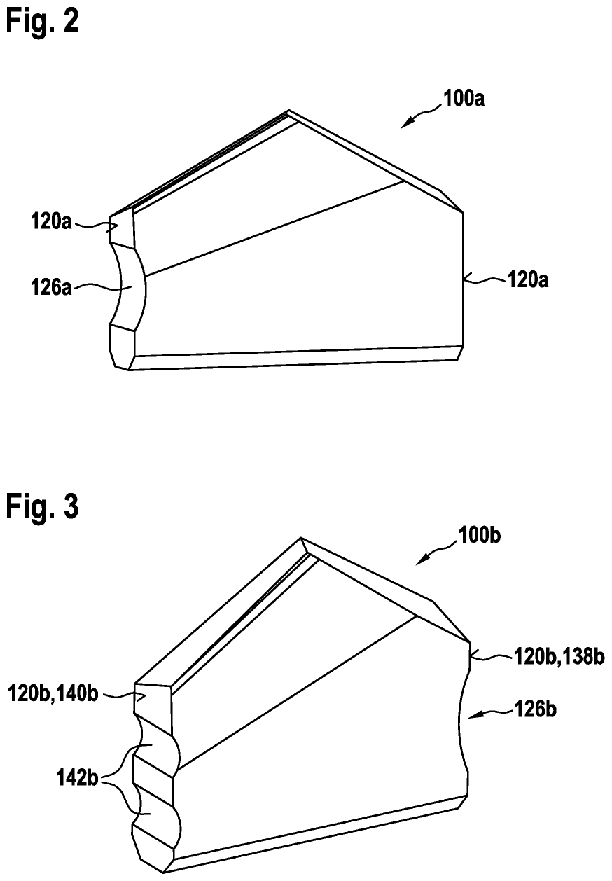

FIG. 2 a perspective view of an alternative embodiment of a cutting body;

FIG. 3 a perspective view of a further alternative embodiment of a cutting body;

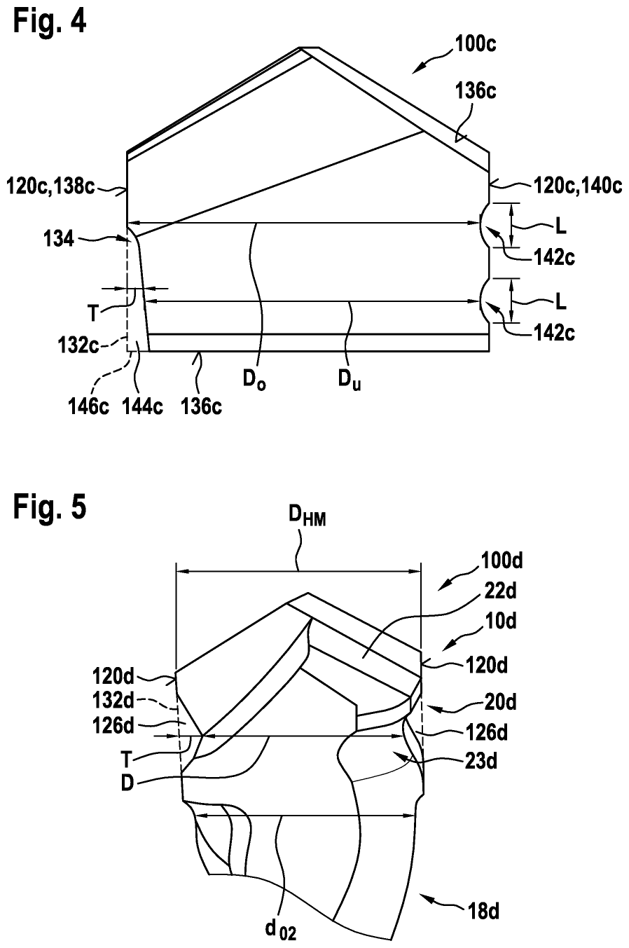

FIG. 4 a side view of a further alternative embodiment of a cutting body;

FIG. 5 a side view of a further alternative embodiment of a cutting body in the state connected to a drilling tool;

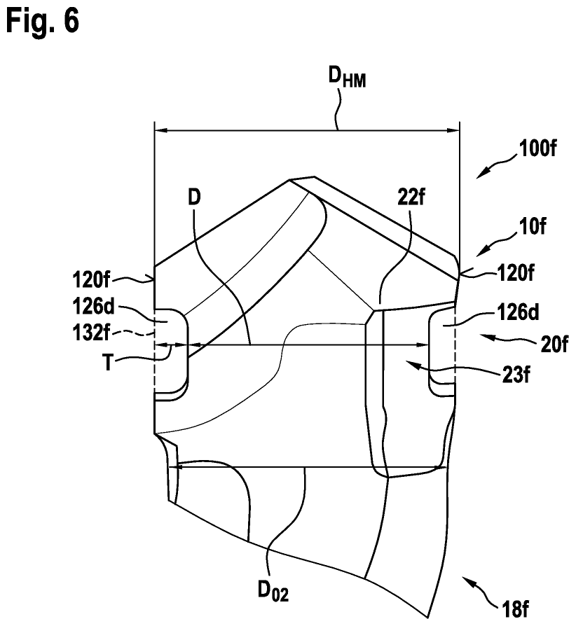

FIG. 6 a side view of a further alternative embodiment of a cutting body in the state connected to a drilling tool.

### DESCRIPTION OF THE EXEMPLARY EMBODIMENTS

In FIG. 1a, a drilling tool 10 with a first embodiment of a cutting body 100 according to the invention is shown in a side view.

The drilling tool 10 is provided for a hand-held tool machine (not shown), such as an impact drilling machine or hammer drill. The drilling tool 10 has a longitudinal axis 12 along which the drilling tool 10 extends. In the state connected with the hand-held tool machine, the drilling tool 10 is rotated about the longitudinal axis 12 to generate a drilled hole. The longitudinal axis 12 thus also corresponds to an axis of rotation of the drilling tool 10.

Along the feed direction 14 of the drilling tool 10, the drilling tool 10 comprises an insertion end 16, a conveyor coil 18 and a drill head 20.

The insertion end 16 is designed in particular for detachable connection of the drilling tool 10 to the hand-held tool machine, in particular without tools. For this purpose, the insertion end 16 comprises a cylindrical round shaft 21, which can be connected to a clamping jaw chuck. The insertion end 16 is in particular designed to be receivable by the hand-held tool machine such that the insertion end 16 is enclosed by the hand-held tool machine in the state when connected to the hand-held machine tool. A diameter of the insertion end 16 is preferably standardized for compatibility with a variety of hand-held tool machines.

The conveyor coil 18 is provided for transporting rock or drill cuttings from a drilled hole. The conveyor coil 18 and the insertion end 16 are exemplary formed as one-piece from a base body 22. The base body 22, in particular the conveyor coil 18 and/or the cutting insertion end 16, are preferably formed from a steel, in particular from an HSS steel.

The conveyor coil 18 has a diameter d₀₂, which corresponds by way of example to a diameter 17 of the insertion end 16. In particular, the diameter d₀₂ of the conveyor coil corresponds to an average diameter of an envelope of the drilling tool 10 in the area of the conveyor coil 18. The envelope of the drilling tool 10 encloses the area taken by the drilling tool 10 in a rotation about the longitudinal axis 12.

Alternatively, it would also be conceivable that the conveyor coil 18 and the insertion end 16 are connected to one another in a bonded manner, for example via a welding method, and thus the base body 22 is designed as one part. It is also conceivable that the conveyor coil 18 has a diameter d₀₂ that is less than or greater than the diameter 17 of the insertion end 16.

By way of example, the diameter d₀₂ of the conveyor coil 18 is slightly smaller than the diameter of the drill head 20. The drill head 20 comprises the cutting body 100, which is exemplary designed as a carbide plate 102.

The drilling tool 10 is shown in a top view in FIG. 1b. The cutting body 100 has a center axis 104 that is exemplary coaxially designed with the longitudinal axis 12 of the drilling tool 10.

The cutting body 100 comprises two cutting elements 106, which are exemplary designed to be rotationally symmetrical to each other. The cutting elements 106 each have a cutting edge 108. The cutting edges 108 correspond to a cutting line of a cutting surface 110 and a flank surface 112. The cutting edges 108 are arranged on a machining surface 114 of the cutting body 100 that forms the face end of the drilling tool 10. The cutting edges 108 are connected by way of a cross-sectional cut 116, by way of example. The transverse edge 116 forms the drill head tip 118 and, by way of example, intersects the center axis 104 of the cutting body 100. The machining surface 114 thus intersects the center axis 104 of the cutting body.

Laterally, the cutting body 100 has two side faces 120 that extend substantially parallel to the center axis 104 of the cutting body 100 and the longitudinal axis 12 of the drilling tool 10, respectively. The two side faces 120 are formed substantially parallel to each other. A maximum diameter D_{HM} of the cutting body 100 corresponds to a maximum distance of the side faces 120 from each other.

The two side faces 120 are connected together via two connection surfaces 124, wherein the connection surfaces 124 each comprise a cutting surface 110. The side faces 120 are designed to be shorter than the connection surfaces 124.

FIG. 1c shows a side view of the cutting body 100 in the state connected to the base body 22 of the drilling tool 10.

The cutting body 100 comprises, e.g., one cutout 126 for each side face 120. The cutout 126 is radially inwardly directed toward the center axis 104 and divides the side face 120 into multiple sub-areas, by way of example, an upper sub-surface 128 and a lower sub-area 130.

The cutouts 126 are designed to increase the drilling speed and/or roughness of the drilled hole to be produced. The cutouts 126 are, e.g., designed to be substantially identical. The cutouts 126 have a concave shape when viewed from the side.

The cutouts 126 comprise three open sides 132, 134. A middle open side 132 thereby interrupts the sub-areas 128, 130 of the respective side face 120. During the drilling operation, the middle open side 132 is closed by an inner wall of the drilled hole. The outer open sides 134 are arranged perpendicular to the middle open side 132 and parallel to each other (see FIG. 1d).

The cutouts 126 are, e.g., designed to be concave. The outer open sides 134 have an exemplary circular segmental cross-section. In particular, the outer open sides 134 have substantially the same cross-section.

A width or diameter D of the cutting body 100 in the area of the cutout 126 corresponds to the maximum diameter (D_{HM}) of the cutting body minus the depths (T) of the cutouts 126. The depth T of the cutouts 126 corresponds to a maximum distance of the cutting body 100 from the middle open side 132 perpendicular to the center axis 104. By way of example, the depth T of the cutouts 126 corresponds to about 10% of a length H_{HM} of the side face 120 (see FIG. 1d). The length H_{HM} of the side face 120 is measured parallel to the center axis 104 of the cutting body 100.

FIG. 1d shows further a side view of the cutting body 100 in the state connected to the base body 22.

The cutting body 100 comprises a joining surface 136 on a side opposite the machining surface 114. In the area of the joining surface 136, the cutting body 100 lies on the latter in a slot of the base body 22 of the drilling tool 10 and is connected to the latter in a bonded manner.

The cutout 126 has a length h, which by way of example corresponds to approximately 50% of the length H_{HM} of the side face 122. The length H_{HM} is in particular the maximum length of the side face 120.

By way of example, a distance C₀ of the cutout 126 to the machining surface 114 is designed larger than a distance C₁ of the cutout 126 to the joining surface 136. The distance C₀ of the cutout 126 to the machining surface 114 particularly corresponds to a length of the upper sub-area 128 of the side face 120. The distance C₁ of the cutout 126 to the joining surface 136 corresponds to the length of the lower sub-area 130 of the side face 120. The length h of the cutout 126 measures, e.g., over 0.15 mm.

In FIG. 2, an alternative embodiment of the cutting body 100a is shown in a perspective view, in which case the cutting body 100a differs from the previous cutting body 100 in particular in that the cutting body 100a has only one side face 120a with a single cutout 126a. The shape and size of the cutout 126a correspond in this case substantially to the previously described cutout 126 shown in FIGS. 1a-d.

FIG. 3 shows a further alternative embodiment of the cutting body 100b in a perspective view. The cutting body 100b comprises two side faces 120b. In particular, the cutting body 100b comprises a first side face 138b having a single cutout 126b. The cutout 126b substantially corresponds to the cutouts 126 previously described. The second side face 140b comprises two second cutouts 142b. The second cutouts are substantially identical in configuration and divide the second side face 140b into three sub-areas. The second cutouts 142b have a depth that is less than a depth of the cutout 126b of the first side face 138b. In addition, the second cutouts 142b have a length that is less than 50% of the length of the first cutout 126b.

FIG. 4 is a side view of a further alternative embodiment of the cutting body 100c. A first side face 138c comprises a cutout 144c with four open sides, wherein a depth T of the cutout 144c increases steadily towards the joining surface 136c. The fourth open side 146c is designed perpendicular to the middle and outer open sides 132c, 134c and is in particular formed by an intended extension of the joining surface 136c.

The second side face 140c comprises two second cutouts 142c. The second cutouts 142c are arranged one below the other and thus have different distances to the machining surface 114c. A length L of the cutouts 142c corresponds to about 20% of the length of the side faces 120c. The depth T of the cutouts 142c is the same. By designing the cutout 144c of the first side face 138c, a diameter Do of the cutting body 100 in the area of the upper second cutout 142c is greater than a diameter Du in the area of the lower second cutout 142c. Advantageously, by combining with a side face with cutouts having exactly three open sides and a side face with a cutout having four open sides, the drilling speed can be further improved.

FIG. 5 shows further alternative embodiment of the cutting body 100d in the state connected to a base body 22d of a drilling tool 10d.

The cutting body 100d comprises two opposing side faces 120d, each having a cutout 126d, the cutouts 126d being designed to be, e.g., concave shaped. The cutouts 126d of the two side faces 120d are designed to be substantially the same.

The cutting body 100d has a diameter D_{HM} that is greater than a diameter d₀₂ of the drilling tool 10d, in particular than a diameter d₀₂ of the conveyor coil 18d of the drilling tool 10d.

The cutouts 126d have a depth T large enough that, in the area of the cutouts 126d, a diameter D of the cutting body 100d corresponds to about 80% of the maximum diameter D_{HM} of the cutting body 100d. The cutting body 100d therefore has a diameter D in the area of the cutouts 126d small enough that it is smaller than the diameter d₀₂ of the drilling tool 10d.

To ensure that the cutouts 126d are not covered by the base body 22d of the drilling tool 10d, the base body 22d has a diameter reduction 23d, which is adapted to the cutouts 126d of the cutting body 100d. Advantageously, the drilling tool 10d therefore has substantially the same diameter as the cutting body 100d in the area of the diameter reduction 23d. By reducing the diameter 23d, the envelope of the drilling tool 10d in the area of the drill head 20d is also locally reduced by about 10% in diameter.

FIG. 6 shows a further alternative embodiment of the cutting body 100f in the state connected to a base body 22f of a drilling tool 10f.

The cutting body 100f comprises two opposing side faces 120f, each having a cutout 126f, the cutouts 126f being designed to be, e.g., rectangular in shape with rounded corners. The cutouts 126f of the two side faces 120f are designed to be substantially the same.

The cutting body 100f is designed to have a diameter D_{HM} that is greater than a diameter d₀₂ of the drilling tool 10f, in particular than a diameter d₀₂ of the conveyor coil 18f of the drilling tool 10f.

The cutouts 126f have a depth T large enough that, in the area of the cutouts 126f, a diameter D of the cutting body 100f corresponds to about 80% of the maximum diameter D_{HM} of the cutting body 100d. The cutting body 100f therefore has a diameter D in the area of the cutouts 126f small enough that it is smaller than the diameter d₀₂ of the drilling tool 10f.

To ensure that the cutouts 126f are not covered by the base body 22f of the drilling tool 10f, the base body 22f has a diameter reduction 23f, which is adapted to the cutouts 126f of the cutting body 100f. Advantageously, the drilling tool 10f therefore has substantially the same diameter as the cutting body 100f in the area of the diameter reduction 23f. By reducing the diameter 23f, the envelope of the drilling tool 10f in the area of the drill head 20f is also locally reduced by about 10% in diameter.

1. A cutting body for a drilling tool comprising:
a center axis;
at least one cutting element having at least one cutting edge; and
at least one side face having at least one radially inwardly directed cutout configured to produce a drilled hole having an increased roughness,
wherein the cutout has precisely three open sides.

2. The cutting body according to claim 1, wherein the cutting body is made of a carbide.

3. The cutting body according to claim 1, wherein the at least one side face has a minimum distance from the center axis in an area of the cutout.

4. The cutting body according to claim 1, further comprising:
a second side face comprising a second cutout with four open sides.

5. The cutting body according to claim 1, wherein the cutout is configured such that a diameter of the cutting body along the center axis in a direction of the cutout initially decreases in size and enlarges after the cutout.

6. The cutting body according to claim 1, wherein the cutout is angular or concave.

7. The cutting body according to claim 1, wherein the at least one radially inwardly directed cutout comprises two or more cutouts defined in the at least one side face.

8. The cutting body according to claim 1, further comprising:
a second side face having at least one second cutout.

9. The cutting body according to claim 1, wherein a distance between the cutout and a machining surface of the cutting body measures within a range of between 10% and 40% of a length of the side face.

10. The cutting body according to claim 1, wherein a length (h) of the cutout measures within a range 0.15 mm≤h≤H_{HM}−C,
wherein:
H_{HM} is a length of the side face, and
C is a distance between the cutout and the machining surface.

11. A drill tool having comprising:
a cutting body comprising:
a center axis to which a longitudinal axis of the drilling tool extends coaxially or parallel;
at least one cutting element having at least one cutting edge; and
at least one side face having a radially inwardly directed cutout configured to produce a drilled hole having an increased roughness, wherein the cutout has precisely three open sides.

12. The drilling tool according to claim 11, wherein the cutting body is integral with the drilling tool or is connected to a base body of the drilling tool in a bonded manner.

13. The drilling tool according to claim 11, further comprising:
a base body,
wherein a diameter of the base body in an area of the cutout substantially corresponds to a minimum diameter of the cutting body.

14. The drilling tool according to claim 11, further comprising:
a base body,
wherein the base body has a diameter reduction in an area of the cutout.

15. The drilling tool according to claim 11, further comprising:
a conveyor coil,
wherein a depth of the cutout measures within a range 0.8*d₀₂≤D≤D_{HM}−0.2*HHM*n,
wherein:
d₀₂ is a diameter of the drilling tool in an area of the conveyor coil,
D_{HM} is a diameter of the cutting body,
H_{HM} is a length of the side face, and
n is a number of side faces of the at least one side face having at least one cutout.

16. The cutting body according to claim 9, wherein the range is between 10% and 30% of the length of the side face.

17. The cutting body according to claim 16, wherein the range between 10% and 20% of the length of the side surface.
